(19) United States
(12) Patent Application Publication
(10) Pub. No.: US 2009/0207198 A1
(43) Pub. Date: Aug. 20, 2009

(54) Offset printing method using inkjet system and product printed thereby

(76) Inventor: Kouji Muraoka, Fukui (JP)

Correspondence Address: LADAS & PARRY LLP, 26 WEST 61ST STREET, NEW YORK, NY, 10023, US

(21) Appl. No.: 11/547,382

(22) PCT Filed: Oct. 5, 2005
(86) PCT No.: PCT/JP2005/018438

§ 371 Date: Oct. 9, 2008

(30) Foreign Application Priority Data
Nov. 4, 2004 (JP) 2004-320420

(51) Int. Cl. B41J 29/38; B41J 2/01

(52) U.S. Cl. 347/6; 347/102

(57) ABSTRACT

An offset printing method using an inkjet system, and a printed product printed thereby. The offset printing method includes a first step of printing a UV ink image on a flat original plate by inkjet using UV-ink, a second step of irradiating the UV ink image with a UV or an electron beam while or immediately after printing the UV ink image, so as to bring the UV ink image into a semi-dried state, a third step of transferring the semi-dried UV ink image to a surface of an elastic blanket, a fourth step of offset-printing the UV ink image transferred to the elastic blanket onto a to-be-printed product, and a step of drying and fixing the offset-printed UV ink image. Viscosity of the UV ink in the first step is set as 3-100 mPaS at 30° C., and viscosity of the UV ink in the second step is set as viscosity equivalent to 0.1-300 PaS at 25° C. in standard UV ink.

### TECHNICAL FIELD

The present invention relates to an offset printing method using an inkjet system, and a product printed thereby.

### BACKGROUND ART

Printing technologies have been developed continuously since days before this century. In recent years, particularly with the development of IC technologies, a printing method using an inkjet system has been developed as a printing method in concert with the computer age, and used in various copying machines and the like.

Of such inkjet systems, an on-demand system for ejecting a jet of ink only on demand is to perform printing under the inkjet conditions controlled in accordance with ever-changing screen information. The on-demand system can perform concurrent control not only on information about a print image itself but also on information about a change in shape of a printed product to be printed. Thus, the on-demand system appears extremely promising as a system for printing on a curved surface.

However, the inkjet system with good printing accuracy is chiefly intended for printing on paper or fabric. There are many potential problems when this system is applied to general offset printing intended for printing on a wide range of products. Particularly, as for printing ink, that is, inkjet ink also having properties suitable for offset printing, it is difficult to select suitable ink, because the required performance of the ink for inkjet differs from that of the ink for offset printing. In order to solve this, various researches have been made. For example, JP-A-10-235989 discloses a technique to allow offset printing to be performed by inkjet by restricting a material of a printing object, on which printing is directly performed by an inkjet system, and a surface structure of the material, particularly the surface roughness. However, the technique cannot be always regarded as satisfactory in terms of printing accuracy.

In inkjet systems in recent years, the maximum resolution is increased to improve the image quality. In accordance with this, it is required to make the ejected particles of ink as small as possible. To this end, ink used in the inkjet systems is generally required to be water base ink including a surface-active agent such as ethylene glycol or the like as an auxiliary agent, so as to have an extremely low viscosity (about 0.1-1 poise) and a high permeability. Thus, the gap between the performance of the ink used in the inkjet systems and the performance of general offset printing ink shows a tendency to increase more and more.

On the other hand, in the case of offset printing where at least a surface of the printing object, on which printing is performed, is made of various materials such as rubber, plastic, metal, etc., ink must be sufficiently fixed to the surface of the printing object. In addition, the ink must have properties satisfying a plurality of conditions that the ink can be intermediately transferred from a flat original plate to a flat or curved elastic blanket for offset printing, and the intermediately transferred ink can be further transferred and fixed onto the final printing object. Current ink of inkjet systems prepared for materials and surface conditions of paper or fabric as the printing object cannot be always regarded as suitable for the offset printing.

### DISCLOSURE OF THE INVENTION

### Problems that the Invention is to Solve

As described above, there are many potential problems in an inkjet system when the inkjet system is applied to offset printing. Particularly, the problems of the printing ink to be used are important. The ink to be used is required to have an extremely low viscosity in view of a balance of a capacity of a cavity and a time system in a step when the cavity is pressed in an inkjet head chip so that the ink from a holding tank is ejected from a nozzle. At the same time, the ink is required to be able to be transferred from an original flat plate to an intermediate blanket (or pad) and to be further transferred onto a final printed product under a preferable condition for accurate printing and fixing. In brief, the point is that the specifications of the printing ink and the printing method have to satisfy these antithetical conditions It has been strongly requested to realize the desired printing ink specifications and the desired printing method.

To meet these requests, it is an object of the present invention to provide an offset printing method using inkjet, which is extremely easy, good in printing accuracy and economical, fundamentally without changing an original plate making step and equipment in the background art, and a product printed in the offset printing method.

### Means for Solving the Problems

The offset printing method according to the present invention is:

1) an offset printing method including a first step of printing a UV ink image on a flat original plate by inkjet using UV ink, a second step of irradiating the UV ink image with a UV or an electron beam while or immediately after printing the UV ink image, so as to bring the UV ink image into a semi-dried state, a third step of transferring the semi-dried UV ink image to a surface of an elastic blanket, a fourth step of offset-printing the UV ink image transferred to the elastic blanket onto a to-be-printed product, and a step of drying and fixing the offset-printed UV ink image.
2) The offset printing method in the aforementioned paragraph 1) is adapted so that the elastic blanket is a flat elastic blanket;
3) the offset printing method in the aforementioned paragraph 1) is adapted so that the elastic blanket is a curved elastic blanket or a roll-like elastic blanket;
4) the offset printing method in the aforementioned paragraph 1)-3) is adapted so that viscosity of the UV ink in the first step is 3-100 mPaS at 30° C.;
5) the offset printing method in the aforementioned paragraph 1)-3) is adapted so that viscosity of the semi-dried UV ink in the second step is viscosity equivalent to 0.1-300 PaS at 25° C. in standard UV ink;
6) the offset printing method in the aforementioned paragraph 1)-5) is adapted so that irradiation conditions of the UV ink in the second step are conditions where output W is 0.1-0.5 KW/cm and irradiation time t is 0.5-5 sec so that the printed UV ink image is brought into the semi-dried state;
7) the offset printing method in the aforementioned paragraph 1)-5) is adapted so that an irradiation condition with the UV or electron beam in the second step is practically ½ to ⅓ time as large as a normal irradiation condition where the print image with the UV ink is perfectly dried;
8) the offset printing method in the aforementioned paragraph 1)-7) is adapted so that the elastic blanket is made of silicon rubber; and
9) the offset printing method in the aforementioned paragraph 1)-8) is adapted so that the ink to be used for inkjet is conductive ink or ink containing organic EL.

The printed product according to the present invention is:

10) a printed product with a surface printed by an offset printing method using an inkjet system according to any one of the aforementioned paragraphs 1) through 9);
11) the printed product in the aforementioned paragraph 10), wherein the printed product is an automobile part;
12) the printed product in the aforementioned paragraph 10), wherein the printed-product is a handle or an interior and exterior member for automobile use;
13) the printed product in the aforementioned paragraph 10), wherein the printed product is an interior or exterior member of electronic equipment;
14) the printed product in the aforementioned paragraph 13), wherein the exterior member of the electronic equipment is an exterior member of a cellular phone;
15) the printed product in the aforementioned paragraph 13), wherein the interior member of the electronic equipment forms an electric circuit;
16) the printed product in the aforementioned paragraph 13), wherein the printed product is an ornament;
17) the printed product in the aforementioned paragraph 13), wherein the ornament is an eyeglass frame.
18) the printed product in the aforementioned paragraph 10), wherein the printed product is an antenna;
19) the printed product in the aforementioned paragraph 10), wherein the printed product is an organic EL product; or
20) the printed product in the aforementioned paragraph 10), wherein the printed product is an electromagnetic wave shielding product.

### EFFECT OF THE INVENTION

According to the present invention, an image printed on a printing original plate by an inkjet system can be printed on a to-be-printed product having a curved surface or the like by offset printing through the printing original plate. Thus, it is possible to provide a printing method for accurately printing print images rich in variety onto curved surfaces as well as flat surfaces, and it is possible to provide printed products more accurate and richer in variety than in the background art.

### BRIEF DESCRIPTION OF THE DRAWINGS

FIG. 1 A flow chart showing the contents of a printing method according to the present invention.

FIG. 2 An explanatory view for explaining respective processes in FIG. 1 as actual operations.

FIG. 3 An explanatory view when a to-be-printed product has a curved surface and a curved elastic blanket is used.

FIG. 4 A diagram showing the relationship between the inkjet adaptability (ejection reliability) and the viscosity of UV ink and the relationship between the transfer efficiency (transfer reliability) to an elastic blanket and the viscosity of UV ink.

### BEST MODE FOR CARRYING OUT THE INVENTION

As described above, the present invention is to perform offset printing using a printing original plate in an inkjet printing system which has showed extreme improvement in printing accuracy and printing variety. The point of the invention lies in preferable printing ink properties required for inkjet printing and offset printing respectively.

The present inventor has obtained knowledge that offset printing using the inkjet system can be performed easily and economically when ultraviolet curing ink (hereinafter referred to as UV ink) is used while predetermined conditions are established.

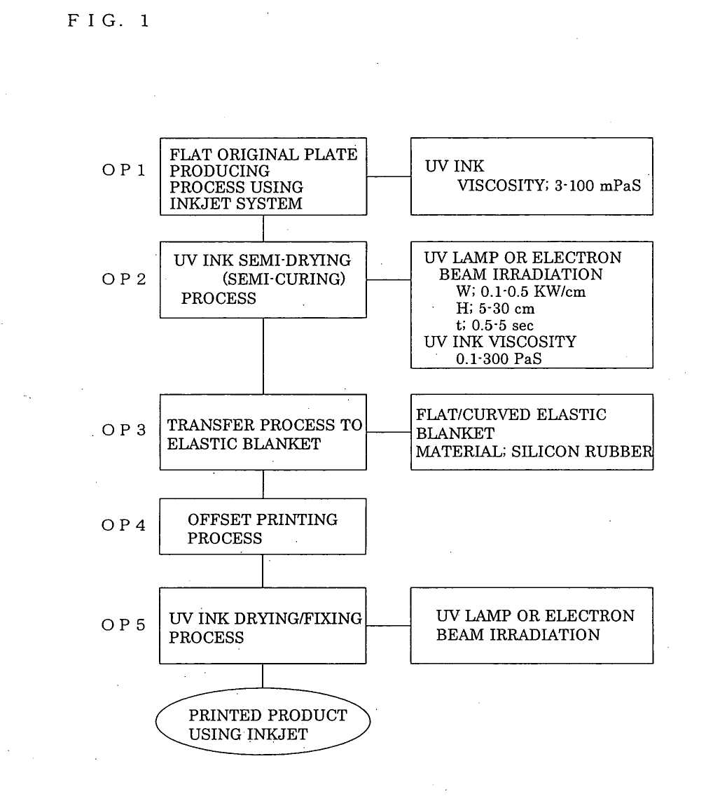

FIG. 1 is a flow chart showing the contents of a printing method according to the present invention.

OP1 designates a print image forming process where a print image is formed on a flat original plate by use of an inkjet system; OP2, a semi-drying (semi-curing) process where UV ink of the print image is semi-dried (semi-cured) by a UV lamp or by irradiation with an electron beam while or immediately after the image is printed on the original plate in OP1; OP3, a transfer process where the semi-dried (semi-cured) print image applied to the printing original plate is transferred to an elastic blanket; OP4, an offset printing process where the elastic blanket having the print image transferred thereto is moved to print the image on a to-be-printed product; and OP5, a drying/fixing process where the UV ink of the offset-printed print image is dried and fixed.

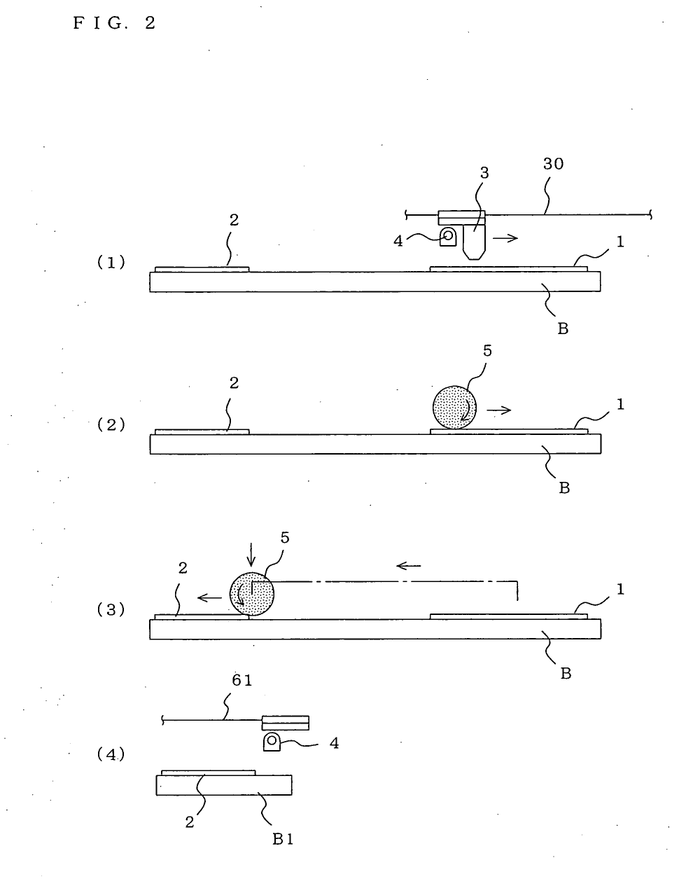

FIG. 2 is an explanatory view for explaining the respective processes in FIG. 1 as actual operations.

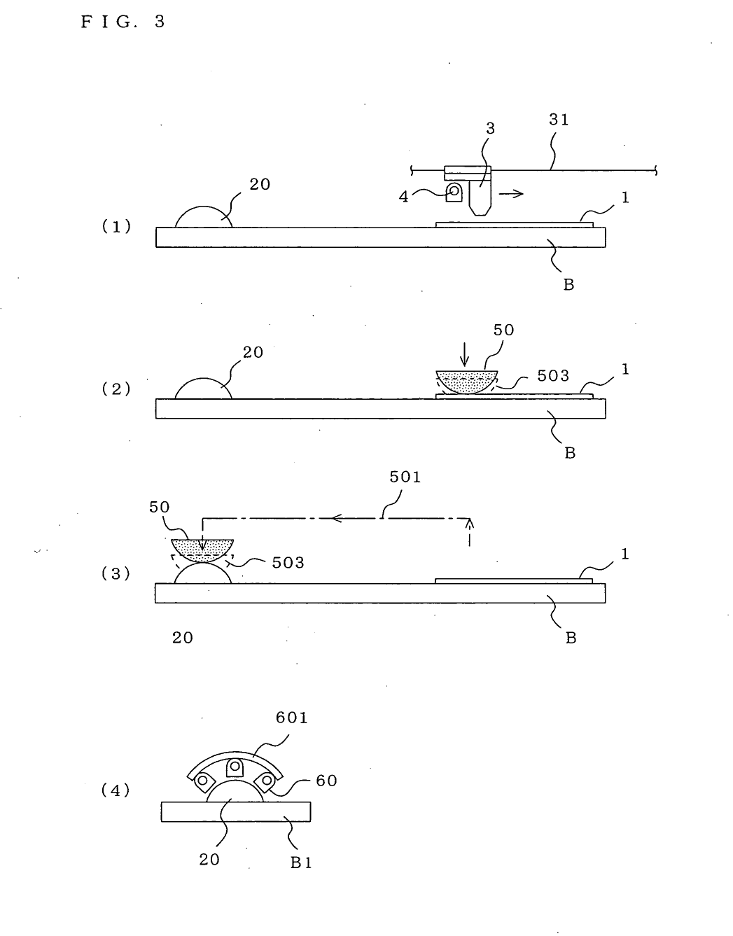

While FIG. 2 is an explanatory view where an elastic blanket has a cylindrical shape, FIG. 3 is an explanatory view where a to-be-printed product has a curved surface and a curved elastic blanket is formed out of a curved surface corresponding to the curved surface of the to-be-printed product.

That is, FIG. 2 shows the case where the to-be-printed product 2 has a flat surface or a curved surface close to a flat surface, and the elastic blanket 5 has a cylindrical shape so that transferring ink of an image by means of an elastic blanket is performed by rolling of the elastic blanket 5. FIG. 3 shows the case where the to-be-printed product 20 has a curved surface.

In the drawings, the reference numeral 1 represents a printing original plate; 2, a to-be-printed product; 20, a to-be-printed product having a curved surface; 3, an inkjet printing device; 31, a feed device (whose power portion is not shown) for feeding the inkjet printing device and an irradiation/curing device working therewith; 4, a UV lamp or an electron beam irradiation/curing device for performing irradiation in predetermined conditions while working with the inkjet device; 5, a cylindrical elastic blanket; 50, a curved elastic blanket; 51, a moving trajectory of the cylindrical elastic blanket from the original plate to the to-be-printed product; 501, a moving trajectory of the curved elastic blanket from the original plate to the to-be-printed product; 502, the curved elastic blanket showing the state where an image on the original plate is being pressed and transferred from the original plate; 503, the curved elastic blanket showing the state where the image is being printed to the to-be-printed product having a curved surface by the curved elastic blanket on the to-be-printed product having a curved surface; 6, a UV ink fixing device (1); 60, a U ink fixing device (2); 61, a support/feed device (i) of the U ink-fixing device (1); 601, a support/feed device (ii) of the UV ink fixing device (2); B, a setting base; and B1, a UV ink fixing base.

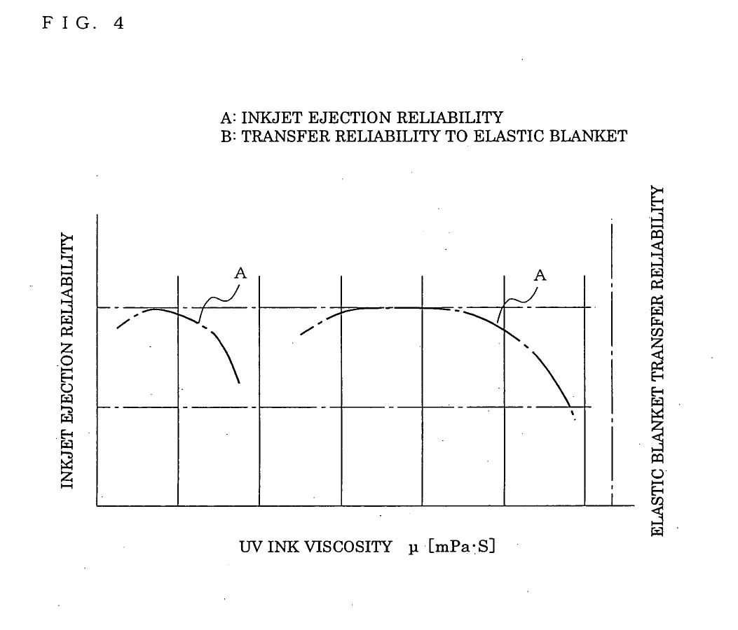

FIG. 4 is a diagram showing experimental results of the adaptability (ejection reliability) with respect to the viscosity of the UV ink used for inkjet, and the transfer efficiency (transfer reliability) to the elastic blanket with respect to the viscosity of the UV ink by way of example, with the abscissa being expressed by logarithm. The former was obtained by measuring image accuracy as compared with computer input data, and the latter was obtained by measuring comparative transfer accuracy to a silicon rubber flat blanket.

In the drawing, the reference sign A designates the relationship between the UV ink viscosity and the ejection accuracy (reliability) in inkjet, and B designates the relationship between the UV ink viscosity and the transfer efficiency (reliability) to the elastic blanket.

The optimum viscosity range of the latter is different from the optimum viscosity range of the former at magnification by the order of 10²-10⁴. It is understood that the adaptive range of the latter can be set to be much wider than that of the former.

The contents of the present invention will be described in detail below.

The printing original plate 1 is set movably on the setting base B in advance. The printing original plate 1 is a thin flat plate made of an aluminum alloy. A sheet material which is called “wastes pan sheet” and which is rich in retentivity of and affinity to the UV ink may be used as the printing original plate 1.

Preferably the inkjet printer 3 has a normal line head chip with a nozzle density of about 20-150 npi. The inkjet printer 3 produces an image under computer control.

In printing of a typical inkjet system, low-viscosity aqueous ink is chiefly used. However, the present invention is characterized by using UV ink particularly having a predetermined viscosity and having a comparatively slow drying/curing time.

Various UV inks to be supplied to the inkjet printer 3 have been placed on the market by makers respectively. As a result of experiments, it is desired in the present invention that the predetermined viscosity is adjusted to be 3-100 mPaS at 30° C. It is preferable to use a two-component type in which acrylate based photopolymerizable resin is used as a base material, while a reducer having a comparatively small amount of photopolymerization initiator and provided for decreasing the viscosity is added by up to 10%.

Normal ink for use in the inkjet printer 3 is required to have a quick-dry property. In the present invention, however, conditions for the UV ink to keep its semi-dried (semi-cured) state during a process have to be provided gradually for a predetermined time.

The second point of the present invention is that the UV ink is set to have semi-dried (semi-cured) ink properties balanced between the retentivity to the elastic blanket 5, 50 and the releasability from the original plate while or immediately after printing is performed by the inkjet printer 3.

That is, the specification of the ink to be ejected from the head chip of the inkjet printer 3 is different from the specification of the ink to be transferred to an elastic pad. This difference in specification can be non-ambiguously interpreted as a difference in viscosity.

As described above, the conditions for the UV ink to keep its semi-dried (semi-cured) state is given to the UV ink gradually for a predeterminedtime. It is thereforepreferable to adjust the properties of the UV ink itself by reduction of photopolymerization initiator or the like, and to loosen the irradiation conditions for drying (curing) the UV ink with a UV or electron beam after inkjet printing on the original plate.

As a result of experiments, it was proved that the viscosity of the UV ink transferable to the elastic blanket 5, 50 or particularly to the surface of an elastic blanket made of silicon rubber has a lower limit at 0.1 PaS and an upper limit at 300 PaS practically. If the viscosity is lower than 0.1 PaS, plate dirt will be caused by ink blur. If the viscosity exceeds 300 PaS, it will be difficult to perform accurate transfer to the elastic blanket surface.

It is therefore desired that the equivalent viscosity of the UV ink in its semi-dried (semi-cured) state is made not lower than 0.1 PaS and not higher than 300 PaS.

In actual working conditions, the semi-dried (semi-cured) state can be obtained practically when the UV or electron beam irradiation condition is made about ½ to ⅓ time as long as the normal dry/irradiation condition of a printed image using the UV ink.

In order to obtain the semi-dried (semi-cured) state stably, it is necessary to narrow down the irradiation energy of the UV or electron beam for drying (curing). As a result of a large number of practical trials made by the applicant, the following knowledge could be obtained. That is, in terms of irradiation conditions, the output W is set as 0.1-0.5 KW/cm and the irradiation time t is set as 0.5-5 sec when the feed velocity V is 0.5 cm/sec. In these irradiation conditions, the printed UV ink image can be brought into the semi-dried state stably. Fundamentally, when the output W is reduced comparatively or when the irradiation distance is increased, the irradiation time t can be increased so that the semi-dried (semi-cured) state can be obtained more stably.

The image printed by inkjet and brought into the semi-dried (semi-cured) state by the process OP3 in FIG. 1 is transferred from the original plate to the elastic blanket. In oP4, the elastic blanket 5, 50 is moved from the position on the original plate 1 onto the to-be-printed product 2 through the moving trajectory 51, 501, and the image is printed on the to-be-printed product 2, 20.

As for the elastic blanket 5, 50 and the specification of the UV ink during this process, it is possible to refer to JP-A-10-235989 “Offset Printing Method Using Inkjet System” and Japanese Patent No. 3166069 “Method for Printing on Curved Surface” filed by the present applicant.

In OP5 of FIG. 1, the UV ink printed on the to-be-printed product is dried and fixed by the UV or electron beam 6, 60. In this case, in actual operation, there occurs a difference in timing between OP1-4 and OP5. Therefore, when the to-be-printed product on which the image has been printed is moved from the setting base B to another UV ink fixing base B1, it is possible to perform well-balanced drying and fixing by the UV or electron beam 6, 60. Not to say, drying and fixing may be performed on the setting base B.

The ink for use in inkjet according to the present invention may be regarded as conductive ink or ink containing organic EL without departing from the aforementioned ink specification conditions. When the conductive ink or the ink containing organic EL is used, the print image printed on the to-be-printed product can be used for an electromagnetic wave energy processing device or particularly an antenna or an electromagnetic wave shielding member. In addition, the print image can be also applied to an IC wiring board.

In this case, as for the specification of electromagnetic powder in the final printed image, the contents of JP-A-2004-055566 and JP-A-2003-306792 filed by the present applicant can be applied.

### Example 1

to-be-printed product: polypropylene plate measuring 200 mm by 200 mm by 1 mm

elastic blanket: material, silicon rubber
cylindrical elastic blanket measuring 70 mmφ (core 20 mmφ) by 250 mm (L)

printing original plate: Al alloy (surface roughness 1.5 s) measuring 300 mm by 300 mm by 1 mm

print image: standard grid pattern with line width 0.5±0.02 mm and grid interval 5+0.03 mm

inkjet printer: mounted with SONY DPPdpp-MP1 head chip
UV ink: FDSS series (color 193 red) for inkjet by Toyo Ink Mfg. Co., Ltd.
moving velocity V; 5 mm/sec

Printer: horizontally movable three-stage type blanket printer (SHUHO-3)

semi-drying (semi-curing) conditions:
irradiation lamp; metal halide lamp 1.5 KW
irradiation distance H; 50 mm
moving velocity V; 5 mm/sec

drying/fixing conditions:
irradiation lamp; metal halide lamp 3 KW (M03-L31)
irradiation distance H; 200 mm
irradiation time t; 1 sec

The aforementioned print image was printed on the printing original plate 1 by the inkjet printer 3 with the moving velocity V set at 5 mm/sec. Immediately after the printing, semi-drying (semi-curing) process was performed by the metal halide lamp (1.5 KW) 4 working with the inkjet printer. At first, the irradiation distance H was set at 30 mm. The image was too much dried (cured) to be transferred. Therefore, the irradiation distance H was set at 50 mm. After the transfer with the cylindrical elastic blanket 5 was confirmed, the image was offset-printed on the to-be-printed product 2. After the image was dried and fixed, the printed condition of the print image surface was observed visually and with a Lupe (20-power)

As a result, it was confirmed that the transfer from the printing original plate was substantially perfect, and the offset printing on the to-be-printed product was also satisfactory.

### Example 2

to-be-printed product: polypropylene bowl-like product measuring 50 mmR, 80 mmφ in bottom surface and 20 mm in height

elastic blanket:
curved elastic blanket; material, silicon rubber
   bowl-like spindle measuring 120 mm in bottom surface, 37 mm in height, 100 mmR in principal curvature radius, 20 mm in eccentricity, and 20 mmR in top portion (90 mmφ in effective bottom surface and 22 mm in effective height)

printing original plate: Al alloy (surface roughness 1.5 s) measuring 200 mm by 200 mm by 1 mm

print image: standard grid pattern with line width 0.5+0.02 mm and grid interval 5+0.03 mm

inkjet printer: mounted with SONY DPPdpp-MP1 head chip
UV ink; FDSS series (color 193 red) for inkjet by Toyo Ink Mfg. Co., Ltd.
moving velocity V; 5 mm/sec

Printer: horizontally movable three-stage type blanket printer (SHUHO-3)

semi-drying (semi-curing) conditions:
irradiation lamp; metal halide lamp 1.5 KW
irradiation distance H; 50 mm
moving velocity V; 5 mm/sec

drying/fixing conditions:
irradiation lamp; metal halide lamp 1.0 KW×4
irradiation distance H; 200 mm
irradiation time t; 1 sec

The aforementioned print image was printed on the printing original plate 1 by the inkjet printer 3 with the moving velocity V set at 5 mm/sec. Immediately after the printing, semi-drying (semi-curing) process was performed by the metal halide lamp (1.5 KW) 4 working with the inkjet printer. The irradiation distance H was set at 50 mm.

After the transfer with the curved elastic blanket 50 was confirmed, the curved elastic blanket 50 was moved onto the to-be-printed product 20 through the moving trajectory 501, andoffset-printing was performed. The to-be-printed product 20 on which the image was printed was moved from the setting base B to the UV ink fixing base B1, and drying/fixing process was performed in the aforementioned drying/fixing conditions by the UV ink fixing device (2) 60.

After the U ink was dried and fixed, the printed condition of the print image surface was observed visually and with a Lupe (20-power).

As a result, it was confirmed that the transfer from the printing original plate was substantially perfect, and accuracy of the offset printing on the to-be-printed product was also satisfactory.

The aforementioned Examples 1 and 2 show examples respectively. Specifications of respective parts are not limited to these.

### INDUSTRIAL APPLICABILITY

By an offset printing method using an inkjet system according to the present invention, printing can be performed accurately and economically on a to-be-printed product having a general curved surface. The offset printing method can be applied to-be-printed products in a broad range of IC-related devices, automobile parts, ornaments, etc.

### DESCRIPTION OF REFERENCE NUMERALS AND SIGNS

1 . . . printing original plate, 2 . . . to-be-printed product, 20 . . . to-be-printed product having a curved surface, 3 . . . inkjet printing device, 31 . . . feed device (whose power portion is not shown) for feeding the inkjet printing device and an irradiation/curing device working therewith, 4 . . . irradiation/curing device using a UV lamp or an electron beam, 5 . . . cylindrical elastic blanket, 50 . . . curved elastic blanket, 51 . . . moving trajectory of the cylindrical elastic blanket from a position on the original plate to the to-be-printed product, 501 . . . moving trajectory of the curved elastic blanket from a position on the original plate to the to-be-printed product, 502 . . . curved elastic blanket showing a pressing/transferring state, 503 . . . curved elastic blanket showing a printing state, 6 . . . UV ink fixing device (1), 60 . . . UV ink fixing device (2), 61 . . . support/feed device (i) of the UV ink fixing device (1), 601 . . . support/feed device (ii) of the UV ink fixing device (2), B . . . setting base, B1 . . . UV ink fixing base, OP1 . . . print image forming process where a print image is formed on the flat original plate by use of an inkjet system, OP2 . . . semi-drying (semi-curing) process where UV ink is semi-dried (semi-cured), OP3 . . . transfer process to the elastic blanket, OP4 . . . offset printing process onto the to-be-printed product, and OP5 . . . drying/fixing process of the UV ink.

1. An offset printing method using an inkjet system, characterized by comprising a first step of printing a UV ink image on a flat original plate by inkjet using UV ink, a second step of irradiating the UV ink image with a UV or an electron beam while or immediately after printing the UV ink image, so as to bring the UV ink image into a semi-dried state, a third step of transferring the semi-dried UV ink image to a surface of an elastic blanket, a fourth step of offset-printing the UV ink image transferred to the elastic blanket onto a to-be-printed product, and a step of drying and fixing the offset-printed UV ink image.

2. The offset printing method using an inkjet system according to claim 1, characterized in that the elastic blanket is a flat elastic blanket.

3. The offset printing method using an inkjet system according to claim 1, characterized in that the elastic blanket is a curved elastic blanket or a roll-like elastic blanket.

4. The offset printing method using an inkjet system according to claim 1, characterized in that viscosity of the UV ink in the first step is 3-100 mPaS at 30° C.

5. The offset printing method using an inkjet system according to claim 1, characterized in that viscosity of the semi-dried UV ink in the second step is viscosity equivalent to 0.1-300 PaS at 25° C. in standard UV ink.

6. The offset printing method using an inkjet system according to claim 1, characterized in that irradiation conditions of the UV ink in the second step are conditions where output W is 0.1-0.5 KW/cm and irradiation time t is 0.5-5 sec so that the printed UV ink image is brought into the semi-dried state.

7. The offset printing method using an inkjet system according to claim 1, characterized in that an irradiation condition with the UV or electron beam in the second step is practically ½ to ⅓ time as large as a normal irradiation condition where the print image with the UV ink is perfectly dried.

8. The offset printing method using an inkjet system according to claim 1, characterized in that the elastic blanket is made of silicon rubber.

9. The offset printing method using an inkjet system according to claim 1, characterized in that the ink to be used for inkjet is conductive ink or ink containing organic EL.

10. A printed product with a surface printed by an offset printing method using an inkjet system according to claim 1.

11. The printed product according to claim 10, characterized in that the printed product is an automobile part.

12. The printed product according to claim 10, characterized in that the printed product is a handle, or an interior and exterior member for automobile use.

13. The printed product according to claim 10, characterized in that the printed product is an interior or exterior member of electronic equipment.

14. The printed product according to claim 13, characterized in that the exterior member of the electronic equipment is an exterior member of a cellular phone.

15. The printed product according to claim 13, characterized in that the interior member of the electronic equipment forms an electric circuit.

16. The printed product according to claim 10, characterized in that the printed product is an ornament.

17. The printed product according to claim 16, characterized in that the ornament is an eyeglass frame.

18. The printed product according to claim 10, characterized in that the printed product is an antenna.

19. The printed product according to claim 10, characterized in that the printed product is an organic EL product.

20. The printed product according to claim 10, characterized in that the printed product is an electromagnetic wave shielding product.
